(19) United States
(12) Patent Application Publication
(10) Pub. No.: US 2018/0363593 A1
(43) Pub. Date: Dec. 20, 2018

(54) VAPORIZED FUEL TREATMENT DEVICE AND LEARNING METHOD OF VALVE OPENING START POSITION OF SEALING VALVE IN VAPORIZED FUEL TREATMENT DEVICE

(71) Applicants: TOYOTA JIDOSHA KABUSHIKI KAISHA, Toyota-shi, Aichi-ken (JP); AISAN KOGYO KABUSHIKI KAISHA, Obu-shi, Aichi-ken (JP)

(72) Inventors: Keita FUKUI, Toyota-shi (JP); Yoshikazu MIYABE, Obu-shi (JP)

(73) Assignees: TOYOTA JIDOSHA KABUSHIKI KAISHA, Toyota-shi, Aichi-ken (JP); AISAN KOGYO KABUSHIKI KAISHA, Obu-shi, Aichi-ken (JP)

(21) Appl. No.: 16/072,405

(22) PCT Filed: Jan. 12, 2017
(86) PCT No.: PCT/JP2017/000747

§ 371 Date: Jul. 24, 2018

(30) Foreign Application Priority Data
Jan. 27, 2016 (JP) 2016-013418

(51) Int. Cl. F02M 25/08; F02D 41/00

(52) U.S. Cl. CPC F02M 25/0836; F02D 41/0032; F02M 25/0872; B01D 2259/4516; F02M 25/089

(57) ABSTRACT

A controller controls a vaporized fuel treatment device including a sealing valve that is disposed in a vapor passage between a fuel tank and a canister and includes a valve element that moves forward and backward in an axial direction with respect to a valve seat. The controller executes a learning of a valve opening start position of the sealing valve based on a change in an internal pressure of the fuel tank when changing an axial distance between the valve element and the valve seat. The controller stores a command value of the axial distance just before an interruption of the learning of the valve opening start position in response to the interruption during an execution of the learning. The controller executes the learning of the valve opening start position while using the command value of the axial distance just before the interruption as an initial command value when a next learning timing is arrived after the interruption.

This is a national phase application of PCT/JP2017/747 filed Jan. 12, 2017, claiming priority to Japanese Patent Application No. JP2016-13418 filed Jan. 27, 2016, the contents of which are incorporated herein by reference.

### TECHNICAL FIELD

The present disclosure relates to a vaporized fuel treatment device with a sealing valve disposed in a vapor passage between a fuel tank and a canister and a learning method of a valve opening start position of the sealing valve in the vaporized fuel treatment device.

### BACKGROUND

A conventionally known vaporized fuel treatment device includes a sealing valve that is driven by a stepper motor and controller that executes a learning of a valve opening start position of the sealing valve based on a change in an internal pressure of a fuel tank when changing an axial distance between a valve element and a valve seat of the sealing valve (as shown in, for example, Patent Literature 1). The controller of the vaporized fuel treatment device moves the valve element by a predetermined stroke at predetermined intervals from a valve closing limit position of the sealing valve and determines whether or not an internal pressure of the fuel tank decreases by a predetermined value or more with respect to a last detected value. Then, the controller judges that the sealing valve starts opening when determining that the internal pressure of the fuel tank decreases by the predetermined value or more with respect to the last detected value and calculates a learning value of the valve opening start position based on a total stroke from the valve closing limit position. Further, the controller determines whether or not an increase amount of the internal pressure of the fuel tank is permissible and interrupts or inhibits the learning of the valve opening start position when determining that the increase amount of the internal pressure of the fuel tank is not permissible during or before the learning.

### CITATION LIST

### Patent Literature

PTL1: Japanese Patent Application Laid Open No. 2015-110914

### Summary

A detected value of a sensor that detects the internal pressure of the fuel tank changes in accordance with both vaporization state of fuel in the fuel tank and a behavior of a vehicle including the vaporized fuel treatment device or a behavior of fuel in the fuel tank. Thus, the learning of the valve opening start position of the sealing valve may be interrupted after a start of the learning when the internal pressure (detected value) changes due to a change in the behavior of fuel in accordance with a movement of the vehicle, for example. Accordingly, if the learning of the valve opening start position is interrupted, it is preferable to complete the learning of the valve opening start position as soon as possible when an execution of the learning is allowed after the interruption of the learning.

A subject matter of the disclosure is to quickly complete the learning of the valve opening start position of the sealing valve when the execution of the learning is allowed after the interruption of the learning.

The disclosure is directed to a vaporized fuel treatment device configured to include a sealing valve that is disposed in a vapor passage between a fuel tank and a canister and is configured to include a valve element that moves forward and backward in an axial direction with respect to a valve seat. The vaporized fuel treatment device is configured to further include a controller programmed to control an opening and closing of the sealing valve and execute a learning of a valve opening start position of the sealing valve based on a change in an internal pressure of the fuel tank when changing an axial distance between the valve element and the valve seat. The controller is programmed to store a command value of the axial distance just before an interruption of the learning of the valve opening start position in response to the interruption during an execution of the learning. Further, the controller is programmed to execute the learning of the valve opening start position while using the command value of the axial distance just before the interruption as an initial command value when a next learning timing is arrived after the interruption.

The controller executes the learning of the valve opening start position of the sealing valve based on the change in the internal pressure of the fuel tank when changing the axial distance between the valve element and the valve seat. The controller stores the command value of the axial distance just before the interruption of the learning of the valve opening start position in response to the interruption during the execution of the learning. Further, the controller executes the learning of the valve opening start position while using the command value of the axial distance just before the interruption as the initial command value when the next learning timing is arrived after the interruption. This configuration enables the learning of the valve opening start position to be completed more quickly on the occasion of the execution of the next learning after the interruption of the learning than a configuration that executes the learning of the valve opening start position while using a command value of the axial distance in a state where the sealing valve is securely closed as the initial command value, for example.

The controller may be programmed to execute the learning of the valve opening start position when the internal pressure of the fuel tank is equal to or smaller than a first threshold value that is smaller than a standard atmosphere pressure and when the internal pressure of the fuel tank is equal to or larger than a second threshold value that is larger than the standard atmosphere pressure.

The fuel tank may store fuel supplied to an engine mounted in a vehicle, and the controller may be programmed to execute the learning of the valve opening start position when the vehicle is stopped.

The disclosure is further directed to a learning method of a valve opening start position of a sealing valve included in a vaporized fuel treatment device. The sealing valve is disposed in a vapor passage between a fuel tank and a canister and is configured to include a valve element that moves forward and backward in an axial direction with respect to a valve seat. The method includes: controlling an opening and closing of the sealing valve and executing a learning of the valve opening start position of the sealing valve based on a change in an internal pressure of the fuel tank when changing an axial distance between the valve element and the valve seat, storing a command value of the axial distance just before an interruption of the learning of the valve opening start position in response to the interruption during an execution of the learning, and executing the learning of the valve opening start position while using the command value of the axial distance just before the interruption as an initial command value when a next learning timing is arrived after the interruption.

The method enables the learning of the valve opening start position of the sealing valve to be completed more quickly when the execution of the learning is allowed after the interruption of the learning.

### BRIEF DESCRIPTION OF DRAWINGS

FIG. 1 is a schematic configuration diagram illustrating a vaporized fuel treatment device according to the disclosure; and

FIG. 2 is a flowchart exemplifying a valve opening start position learning routine executed in the vaporized fuel treatment device according to the disclosure.

### DESCRIPTION OF EMBODIMENTS

The following describes some embodiments of the disclosure with reference to drawings.

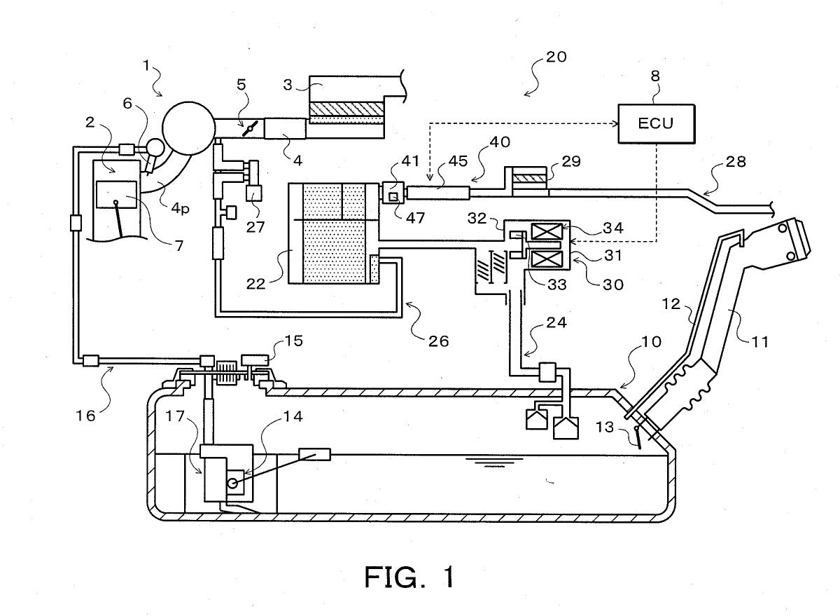

FIG. 1 is a schematic configuration diagram illustrating a vaporized fuel treatment device 20 according to the disclosure. The vaporized fuel treatment device 20 illustrated in FIG. 1 is configured to prevent vaporized fuel generated in a fuel tank 10 storing fuel that is supplied to combustion chambers 2 of an engine (internal combustion engine) 1 mounted in a vehicle (not shown) from leaking outside of the fuel tank 10. In the engine 1, air cleaned by an air cleaner 3 is taken into each of the combustion chambers 2 via an intake pipe 4, a throttle valve 5, intake valves (not shown) and the like. The fuel is injected to the intake air by fuel injection valves 6 in either inlet ports 4p or the combustion chamber 2. Air-fuel mixture is ignited with spark generated by a spark plug (not shown) and is explosively combusted in the combustion chambers 2 so as to reciprocatingly move pistons 7. The engine 1 is controlled by an electric control unit (hereinafter referred.to as “ECU”) 8 that includes a microcomputer with a CPU and the like (not shown). The vehicle with the engine 1 may be either a vehicle that includes only the engine 1 as a power source generating power for driving or a hybrid vehicle that includes a motor generating power for driving in addition to the engine 1.

The fuel tank 10 is configured to, include a fuel inlet pipe 11 for supplying the fuel to the fuel tank 10 via a fuel filler (not shown) of the vehicle, a vent line 12, a check valve 13 that regulates the fuel from flowing back from the fuel tank 10 to the fuel filler, a fuel sender gauge 14 that detects a surface level of the fuel in the fuel tank 10 by means of a float, a tank internal pressure sensor 15 that detects an internal pressure Ptk of the fuel tank 10 and the like. The fuel sender gauge 14 and the tank internal pressure sensor 15 respectively send a signal indicating a detected value to the ECU 8. A fuel passage 16 is connected to an upper portion of the fuel tank 10 and a fuel pump module 17 is disposed in the fuel tank 10. The fuel pump module 17 is controlled by the ECU 8 and is connected to the fuel passage 16. The fuel is pressurized by the fuel pump module 17 so as to be supplied to the fuel injection valves 6 of the engine 1 via the fuel passage 16.

As shown in FIG. 1, the vaporized fuel treatment device 20 is configured to include a canister 22, a vapor passage 24 connecting the fuel tank 10 and the canister 22, a purge passage 26, atmosphere passage 28 and a sealing valve 30 disposed in the middle of the vapor passage 24. The canister 22 includes an active charcoal or an absorbent disposed therein so as to absorb the vaporized fuel in the fuel tank 10 by means of the active charcoal. One end portion (upstream side end portion) of the vapor passage 24 is connected to the fuel tank 10 so as to communicate with a gaseous layer in the fuel tank 10. The other end portion (downstream side end portion) of the vapor passage 24 is connected to the canister 22 so as to communicate with the inside of the canister 22.

One end portion (upstream side end portion) of the purge passage 26 is connected to the canister 22 so as to communicate with the inside of the canister 22. The other end portion (downstream side end portion) of the purge passage 26 is connected to the intake pipe 4 at a downstream side of the throttle valve 5 of the engine 1. A purge valve 27 capable of cutting off the purge passage 26 is disposed in the middle of the purge passage 26. The purge valve 27 is an on-off valve that is controlled by the ECU 8 and is normally maintained in a close state. Further, one end portion of the atmosphere passage 28 is connected to the canister 22 via key-off pump module 40 or a diagnostic equipment that is used for a fault diagnosis of the vaporized fuel treatment device 20. The key-off pump module 40 is configured to include a switching valve 41 that is an on-off valve (cut-off valve) controlled by the ECU 8, a vacuum pump (pressure reduction pump) 45 controlled by the ECU 8 and a canister internal pressure sensor 47 that detects an internal pressure Pc of the canister 22 and sends the detected internal pressure Pc to the ECU 8. The switching valve 41 allows a communication between the inside of the canister 22 and the atmosphere passage 28 in an open state and cuts off the communication between the inside of the canister 22 and the atmosphere passage 28 in a close state. The vacuum pump 45 is capable of reducing the internal pressure of the canister 22 (generating a negative pressure in the canister 22) when the switching valve 41 is closed. Further, an air filter 29 is disposed in the middle of the atmosphere passage 28 and the other end portion of the atmosphere passage 28 is opened to the atmosphere.

The sealing valve 30 is a flow control valve that is controlled by the ECU 8. The sealing valve 30 seals the vapor passage 24 in a close state so as to cut off the communication between the canister 22 and the atmosphere passage 28. The sealing valve 30 regulates a flow rate of vapor flowing in the vapor passage 24 in an open state. The sealing valve 30 is configured to include casing 31, a valve seat 32 formed in the casing 31, a valve element 33 disposed in the casing 31 so as to be movable in an axial direction, and stepper motor 34 disposed in the casing 31 and connected to the valve element 33 via a valve guide (not shown). The stepper motor 34 is controlled by the ECU 8 and allows the valve element 33 to move forward and backward in the axial direction with respect to a valve seat 32. When the valve element 33 approaches the valve seat 32 in accordance with an operation of the stepper motor 34, a seal member (not shown) of the valve element 33 contacts with the valve seat 32 so as to close the sealing valve 30. When the valve element 33 moves away from the valve seat 32 in accordance with the operation of the stepper motor 34, the seal member of the valve element 33 moves away from the valve seat 32 so as to open the sealing valve 30.

In the above vaporized fuel treatment device 20, the sealing valve 30 is maintained in the close state when the vehicle is parked (when an operation of the engine 1 is stopped) so that the vaporized fuel in the fuel tank 10 dose not flow into the canister 22. When the vehicle is parked, the purge valve 27 is closed so as to maintain the purge passage 26 in a cut-off state and the switch valve 41 is opened so as to maintain the communication between the canister 22 and the atmosphere passage 28. Further, in the vaporized fuel treatment device 20, the ECU 8 is programmed to diagnose whether or nota leakage occurs in the vapor passage 24 and the purge passage 26 during a Key-off period of the vehicle in which an ignition switch (start switch) is turned off (the operation of the engine 1 is stopped).

When a predetermined learning execution condition is satisfied after the ignition switch is turned on, a learning of a valve opening start positon of the sealing valve 30 is executed based on a change in the internal pressure of the fuel tank 10 when changing an axial distance between the valve element 33 and the valve seat 32. The ECU 8 opens the purge valve 27 while maintaining the communication between the inside of the canister 22 and the atmosphere passage 28 when the vehicle is driven and a predetermined purge condition is satisfied. As a result, an intake negative pressure of the engine 1 (intake pipe 4) is introduced into the canister 22 via the purge passage 26 so that air flows into the canister 22 from the atmosphere passage 28. Further, the ECU 8 opens the sealing valve 30 so as to release the internal pressure of the fuel tank 10 when the purge valve 27 is opened and the internal pressure Ptk of the fuel tank 10 is equal to or more than a predetermined value. As a result, the vapor (vaporized fuel) in the fuel tank 10 flows into the canister 22 via the vapor passage 24 (sealing valve 30). The absorbent of the canister 22 is purged by the air flowing into the canister 22 and the like. The vaporized fuel desorbed from the absorbent is introduced to the intake pipe 4 of the engine 1 together with air and is combusted in the combustion chambers 2.

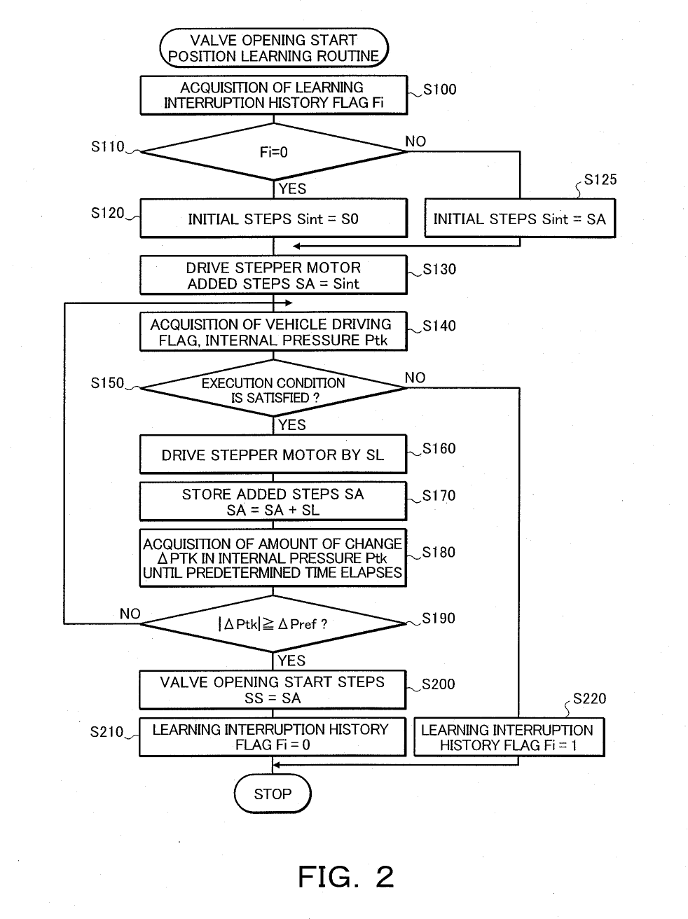

The following describes a learning procedure of the valve opening start positon of the sealing valve 30 in the vaporized fuel treatment device 20 with reference to FIG. 2. FIG. 2 is a flowchart exemplifying a valve opening start position learning routine executed by the ECU 8.

In the embodiment, the valve opening start position learning routine of FIG. 2 is executed when the vehicle is stopped and the internal pressure Ptk of the fuel tank 10 is equal to or smaller than a first threshold value Pa that is smaller than a standard atmosphere pressure and when the vehicle is stopped and the internal pressure Ptk of the fuel tank 10 is equal to or larger than a second threshold value Pb that is larger than the standard atmosphere pressure. As shown in FIG. 2, the ECU 8 (CPU not shown) acquires a value of a learning interruption history flag Fi at the start of the valve opening start position learning routine (Step S100). The learning interruption history flag Fi is set to value 0 when the routine is successfully completed at a last execution and is set to value 1 when the routine is not successfully completed at the last execution due to an interruption of the routine. Then, the ECU determines whether or not there is a history of the interruption of the learning based on the value of the learning interruption history flag Fi (Step S110).

When determining that the value of learning interruption history flag Fi is value 0 and there is no history of the interruption of the learning (Step S110: YES), the ECU 8 sets initial steps Sint that is an initial command value to the stepper motor 34 of the sealing valve 30 to a predetermined limit valve closing steps SO (Step S120). The limit valve closing steps S0 is predetermined as required steps of the stepper motor 34 (a command value of the axial distance between the valve element 33 and the valve seat 32) to move the valve element 33 from a position where the sealing valve 30 is fully opened to a position where the valve element 33 still contacts with the valve seat 32 just before the sealing valve 30 is opened. When determining that the value of learning interruption history flag Fi is value 1 and there is the history of the interruption of the learning (Step S110: NO), on the other hand, the ECU 8 sets the initial steps Sint to added steps SA stored in a RAM (not shown) of the ECU 8 (Step S125). The added steps SA is equivalent to a command value of the axial distance between the valve element 33 and the valve seat 32, that has been used for controlling the stepper motor 34.

After Step S120 or S125, the ECU 8 controls the stepper motor 34 so that a rotor of the stepper motor 34 rotates (at high speed) by the set initial steps Sint and stores the initial steps Sint in the RAM as the added steps SA (Step S130). Further, the ECU 8 acquires a value of a vehicle driving flag and the internal pressure Ptk of the fuel tank 10 detected by the tank internal pressure sensor 15 (Step S140). Then, the ECU 8 determines whether or not the execution condition of the learning of the valve opening start position is satisfied based on the value of the vehicle driving flag and the internal pressure Ptk of the fuel tank 10 (Step S150). The vehicle driving flag is set to value 1 when the vehicle is driven and is set to value 0 when the vehicle is stopped. At Step S150, the ECU 8 determines that the execution condition of the learning of the valve opening start position is satisfied when the vehicle is stopped so that the value of the vehicle driving flag is value 0 and the internal pressure Ptk of the fuel tank 10 is equal to or smaller than the first threshold value Pa and when the vehicle is stopped so that the value of the vehicle driving flag is value 0 and the internal pressure Ptk of the fuel tank 10 is equal to or larger than the second threshold value Pb.

When determining that the execution condition of the learning of the valve opening start position is satisfied at Step S150, the ECU 8 controls the stepper motor 34 so that the rotor of the stepper motor 34 rotates by predetermined learning steps SL (for example, several steps) at Step S160. Then, the ECU 8 stores the sum of the added steps SA at the time and the learning steps SL in the RAM as the new added steps SA (Step S170). Further, the ECU 8 acquires (calculates) an amount of change ΔPtk in the internal pressure Ptk until a predetermined time (for example, several hundred milliseconds) elapses after the rotor is rotated by the learning steps SL, based on the internal pressure Ptk of the fuel tank 10 detected by the tank internal pressure sensor 15 (Step S180). Then, the ECU 8 determines whether or not an absolute value of the acquired amount of change ΔPtk is equal to or larger than a predetermined threshold value ΔPref (positive value) at Step S190.

When determining that the absolute value of the amount of change ΔPtk of the internal pressure Ptk is smaller than the predetermined threshold value ΔPref, the ECU 8 judges that the sealing valve 30 does not start opening so that the internal pressure Ptk of the fuel tank 10 does not substantially change and executes processes of and after Step S140 again. When determining that the absolute value of the amount of change ΔPtk of the internal pressure Ptk is equal to or larger than the threshold value ΔPref, on the other hand, the ECU 8 judges that the sealing valve 30 starts opening so that the internal pressure Ptk of the fuel tank 10 substantially changes and stores the added steps SA stored in the RAM at the time (stored in the RAM at last Step S170) as a valve opening start steps SS that is a learning value of the valve opening start position in the RAM (Step S200). Then, the ECU 8 sets the learning interruption history flag Fi to value 0 (Step S210) and terminates the routine. When executing the processes of and after Step S140 again and determining that the execution condition of the learning of the valve opening start position is not satisfied at Step S150, the ECU 8 interrupts the learning of the valve opening start position. Further, the ECU 8 sets the learning interruption history flag Fi to value 1 (Step S220) and terminates the routine.

The ECU 8 or a controller of the vaporized fuel treatment device 20 is programmed to execute the valve opening start position learning routine of FIG. 2 as described above and learns the valve opening start position of the sealing valve 30 based on the change in the internal pressure Ptk of the fuel tank 10 when changing the steps of the stepper motor 34 of the sealing valve 30 or the axial distance between the valve element 33 and the valve seat 32. Further, the ECU 8 stores the added steps SA that is equivalent to the command value of the axial distance just before the interruption of the learning of the valve opening start position in the RAM (Step S170 just before a negative determination at Step S150) in response to the interruption during the execution of the learning (Step S150: NO). Then, the ECU 8 sets the added steps SA stored in the RAM at the time or the command value of the axial distance just before the interruption as the initial command value (Step S125) when the next learning timing is arrived after the interruption and executes the learning of the valve opening start position while using the initial command value. This configuration enables the learning of the valve opening start position to be completed more quickly on the occasion of the execution of the next learning after the interruption of the learning than a configuration that executes the learning of the valve opening start position while using a command value of the axial distance in a state where the sealing valve 30 is securely closed (for example, the limit valve closing steps S0) as the initial command value.

As has been described above, the vaporized fuel treatment device 20 of the disclosure is configured to include the sealing valve 30 and the ECU 8 that is programmed to control the opening and closing of the sealing valve. The sealing valve 30 is disposed in the vapor passage 24 between the fuel tank 10 and the canister 22 and is configured to include the valve element 33 that moves forward and backward in the axial direction with respect to the valve seat 32. The ECU 8 is programmed to execute the learning of the valve opening start position of the sealing valve 30 based on the change in the internal pressure Ptk of the fuel tank 10 when changing the axial distance between the valve element 33 and the valve seat 32. The ECU 8 stores the added steps SA or the command value of the axial distance just before the interruption of the learning of the valve opening start position (Step S170) in response to the interruption during the execution of the learning (Step S150: NO). Further, the ECU 8 is programmed to execute the learning of the valve opening start position while using the added steps SA or the command value of the axial distance just before the interruption as the initial command value when the next learning timing is arrived after the interruption (Step S125). This configuration enables the learning of the valve opening start position of the sealing valve 30 to be completed more quickly when the execution of the learning is allowed after the interruption of the learning.

The disclosure is not limited to the above embodiments in any sense but may be changed, altered or modified in various ways within the scope of extension of the disclosure.

Additionally, the embodiments described above are only concrete examples of some aspect of the disclosure described in Summary and are not intended to limit the elements of the disclosure described in Summary.

### INDUSTRIAL APPLICABILITY

The techniques according to the disclosure is applicable to, for example, the field of manufacture of the vaporized fuel treatment device.

1. A vaporized fuel treatment device configured to include a sealing valve that is disposed in a vapor passage between a fuel tank and a canister and is configured to include a valve element that moves forward and backward in an axial direction with respect to a valve seat, the vaporized fuel treatment device comprising:
a controller programmed to control an opening and closing of the sealing valve and execute a learning of a valve opening start position of the sealing valve based on a change in an internal pressure of the fuel tank when changing an axial distance between the valve element and the valve seat, the controller programmed to store a command value of the axial distance just before an interruption of the learning of the valve opening start position in response to the interruption during an execution of the learning, the controller programmed to execute the learning of the valve opening start position while using the command value of the axial distance just before the interruption as an initial command value when a next learning timing is arrived after the interruption.

2. The vaporized fuel treatment device according to claim 1, wherein the controller is programmed to execute the learning of the valve opening start position when the internal pressure of the fuel tank is equal to or smaller than a first threshold value that is smaller than a standard atmosphere pressure and when the internal pressure of the fuel tank is equal to or larger than a second threshold value that is larger than the standard atmosphere pressure.

3. The vaporized fuel treatment device according to claim 1,
wherein the fuel tank stores fuel supplied to an engine mounted in a vehicle, and wherein the controller is programmed to execute the learning of the valve opening start position when the vehicle is stopped.

4. A learning method of a valve opening start position of a sealing valve included in a vaporized fuel treatment device, the sealing valve disposed in a vapor passage between a fuel tank and a canister and configured to include a valve element that moves forward and backward in an axial direction with respect to a valve seat, the method comprising:
controlling an opening and closing of the sealing valve and executing a learning of the valve opening start position of the sealing valve based on a change in an internal pressure of the fuel tank when changing an axial distance between the valve element and the valve seat,
storing a command value of the axial distance just before an interruption of the learning of the valve opening start position in response to the interruption during an execution of the learning, and
executing the learning of the valve opening start position while using the command value of the axial distance just before the interruption as an initial command value when a next learning timing is arrived after the interruption.
